(19) United States
(12) Patent Application Publication
(10) Pub. No.: US 2016/0097508 A1
(43) Pub. Date: Apr. 7, 2016

(54) LED HEADLIGHT HEAT DISSIPATION DEVICE

(71) Applicants: MING-HSIEN TSAI, TAINAN CITY (TW); SEN-YUNG LEE, TAINAN CITY (TW); HAN-TAW CHEN, TAINAN CITY (TW)

(72) Inventors: MING-HSIEN TSAI, TAINAN CITY (TW); SEN-YUNG LEE, TAINAN CITY (TW); HAN-TAW CHEN, TAINAN CITY (TW)

(21) Appl. No.: 14/503,618

(22) Filed: Oct. 1, 2014

(51) Int. Cl. F21S 8/10; F21V 29/00

(52) U.S. Cl. CPC F21S 48/328; F21S 48/321; F21V 29/2206

(57) ABSTRACT

A headlight heat dissipation device includes a headlight casing which has at least one hole and at least one metal-made and heat-conducting unit covers the at least one hole. The at least one metal-made and heat-conducting unit includes at least one slot which communicates with the at least one hole. A water-proof and air-permeable unit is mounted to the at least one metal-made and heat-conducting unit and covers the at least one slot. The at least one metal-made and heat-conducting unit has an extension portion located in the headlight casing and the extension portion is connected with the light source so as to transfer the heat from the light source to the at least one metal-made and heat-conducting unit to quickly bring the heat away from the headlight casing.

### BACKGROUND OF THE INVENTION

1. Fields of the Invention

The present invention relates to a heat dissipation device, and more particularly, to a heat dissipation device for an LED headlight and the heat dissipation device has at least one metal-made heat-conduction unit to dissipate the heat from the inside of the headlight.

2. Descriptions of Related Art

One of the conventional headlights uses Light Emitting Diodes (LEDs) as the light source and which reduce the size of the headlights.

However, the energy of the LEDs only transfer 15% to 20% to be light, and 80% to 85% of the energy of the LEDs is transferred as heat which may reduce the efficiency of the LEDs. The decay of the yellow light is significant among the light of the LEDs. When the temperature is raised from 25 to 100 degrees Celsius, the decay rate of the yellow light may reach up to almost 75%. Therefore, the heat dissipation is a key issue for an LED headlight.

Taiwan Patent No. I384163 discloses a water-proof and air permeable fabric which is developed to provide a path of heat dissipation, however, the fabric is made by non-woven fabric which is weak and needs a protection case to avoid it from being damaged. Once the fabric is broken, water can enter into the headlight. Besides, most of the casing of the headlight is made of Polycarbonate or the like and which has worse heat dissipation feature, so that even when cooperated with the water-proof and air permeable fabric, the efficiency for bringing heat away from the headlight is not satisfied.

Taiwan Patent No. I250839 discloses a heat dissipation board which is made of metal or plastic non-metal material, multiple holes are defined through the board. The board is coated with heat-conduction material. Nevertheless, the non-metal material is easily broken and the heat conduction feature of the heat-conduction material is not satisfied.

Furthermore, the processes for coating the heat-conduction material on the inside of the headlight casing via the holes are complicated.

Taiwan Patent No. I283634 discloses a material for the headlight casing, the disclosure involves a long-term of manufacturing processes and the strength of the casing is weak and difficult to be cooperated with the headlight casing.

Taiwan Publication No. 201312046 discloses a multiple-hole agent used for headlight casing, wherein the manufacturing cost is too high to be mass-production. Taiwan Utility Model No. M462343 discloses is an illumination device with ventilation tubes, however, the ventilation tube affect the illumination scope and direction, so that the device cannot be used on headlights.

Taiwan Utility Model No. 462323 discloses heat dissipation device made by plastic, however, the main heat conduction body cannot be made by way of plastic molding ejection.

The present invention intends to provide a heat dissipation device for an LED headlight, the heat dissipation device eliminates the shortcomings mentioned above.

### SUMMARY OF THE INVENTION

The present invention relates to a headlight heat dissipation device and comprises a headlight casing having at least one hole, and at least one metal-made and heat-conducting unit covers the at least one hole.

Preferably, the at least one metal-made and heat-conducting unit is board-shaped.

Preferably, there are two metal-made and heat-conducting units connected to the outside of the headlight casing and the inside of the headlight casing. The metal-made and heat-conducting unit that is connected to the inside of the headlight casing extends along the inside of the headlight casing.

Preferably, the at least one metal-made and heat-conducting unit has a sidewall and a bent portion which is connected to a lower end of the sidewall. The sidewall is engaged with the at least one hole.

Preferably, the at least one metal-made and heat-conducting unit is a cup-shaped unit.

Preferably, the sidewall includes three elongate plate, each elongate plate is connected with the bent portion which has the same width of each of the elongate plates.

Preferably, the at least one metal-made and heat-conducting unit comprises multiple fins.

Preferably, the at least one metal-made and heat-conducting unit comprises continuously bent potions and each bent portion has at least one U-shaped portion.

Preferably, the at least one metal-made and heat-conducting unit comprises a least one slot which communicates with the at least one hole. A water-proof and air-permeable unit is mounted to the at least one metal-made and heat-conducting unit and covers the at least one slot.

Preferably, the at least one hole is defined in the top of the headlight casing.

Preferably, the at least one metal-made and heat-conducting unit has an extension portion located in the headlight casing.

Preferably, the extension portion is a curved portion.

Preferably, the extension portion is connected with a heat-conducting member which has at least one connection portion.

Preferably, the casing has a headlight located therein, the headlight has at least one light source. The extension portion is connected to the at least one metal-made and heat-conducting unit and the light source.

Preferably, the heat-conducting member has at least one connection portion which is connected with the light source.

Preferably, the at least one light source comprises at least one Light Emitting Diode or a bulb.

The headlight casing has at least one hole and the at least one metal-made and heat-conducting unit is connected to the at least one hole by multiple ways such as welding, threading, riveting or gluing. The at least one metal-made and heat-conducting unit connected with the at least one hole increases contact area between the hot air in the headlight casing and the air outside of the headlight casing. The air outside of the headlight casing moves while the vehicle moves so as to quickly bring the heat away from the light source in the headlight casing.

The water-proof and air-permeable unit is mounted to the at least one metal-made and heat-conducting unit and covers the at least one slot so as to prevent water from entering into the headlight casing, and the air is permeable through the water-proof and air-permeable unit. The water-proof and air-permeable unit is mounted to sidewall of the at least one metal-made and heat-conducting unit so that the water-proof and air-permeable unit is not easily broken.

The hot air is escaped from the headlight casing from the hole at the top of the headlight casing and the cold air enters into the headlight casing from the hole at the bottom of the headlight casing. The heat is also brought out from the headlight casing by the extension portion and the at least one metal-made and heat-conducting unit.

The present invention is easily used to the headlight casing by simply drilling holes through the headlight casing, and the at least one metal-made and heat-conducting unit can be engaged with the holes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the first embodiment of the heat dissipation device of the present invention;

FIG. 2 is a cross sectional view of the second embodiment of the heat dissipation device of the present invention;

FIG. 3 is an exploded view of the third embodiment of the heat dissipation device of the present invention;

FIG. 4 is a cross sectional view to view that the third embodiment of the heat dissipation device of the present invention is connected to a headlight casing;

FIG. 5 is an exploded view of the fourth embodiment of the heat dissipation device of the present invention;

FIG. 6 is a cross sectional view to view that the fourth embodiment of the heat dissipation device of the present invention is connected to a headlight casing;

FIG. 7 is an exploded view of the fifth embodiment of the heat dissipation device of the present invention;

FIG. 8 is a cross sectional view to view that the fifth embodiment of the heat dissipation device of the present invention is connected to a headlight casing;

FIG. 9 is an exploded view of the sixth embodiment of the heat dissipation device of the present invention;

FIG. 10 is an exploded view of the seventh embodiment of the heat dissipation device of the present invention, and

FIG. 11 is a cross sectional view to view that the seventh embodiment of the heat dissipation device of the present invention is connected to a headlight casing.

### DETAILED DESCRIPTION OF THE PREFERRED EMBODIMENT

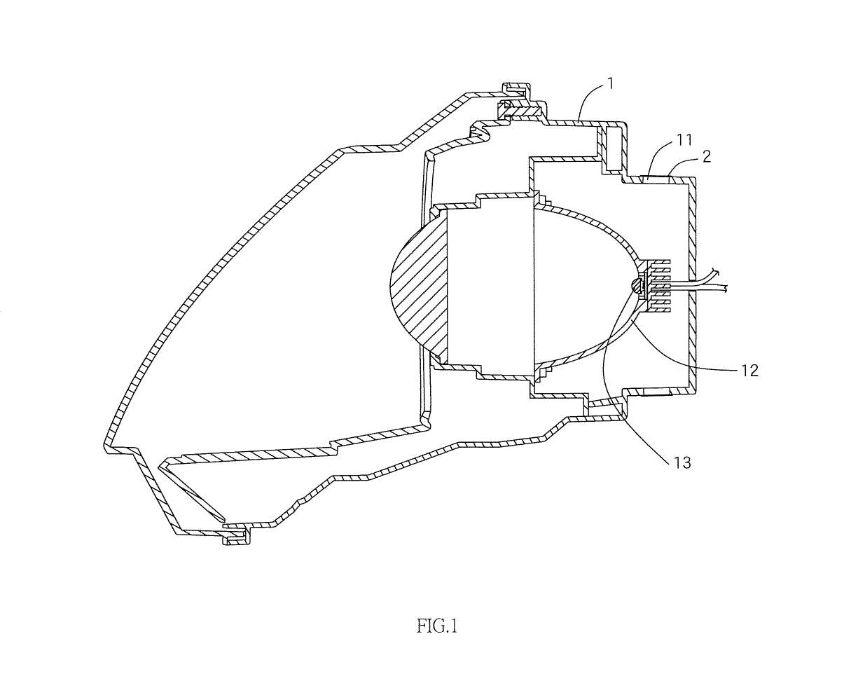

Referring to FIG. 1, the LED headlight heat dissipation device of the present invention comprises a headlight casing 1 having at least one hole 11 located at the top thereof At least one metal-made and heat-conducting unit 2 covers the at least one hole 11. In this embodiment, the at least one metal-made and heat-conducting unit 2 is board-shaped. The at least one metal-made and heat-conducting unit 2 is connected to the at least one hole 11 by multiple ways such as welding, threading, riveting or gluing. The at least one metal-made and heat-conducting unit 2 connected with the at least one hole 11 increase contact area between the hot air in the headlight casing 1 and the air outside of the headlight casing 1. The headlight casing 1 has a headlight 12 installed therein and the headlight has at least one light source 13. The at least one light source 13 comprises at least one Light Emitting Diode (LED) or a bulb.

The at least one metal-made and heat-conducting unit 2 is made by metal which has higher heat transfer coefficient, and the hot air due to the at least one light source 13 has lower density, so that the hot air moves upward and the heat is transferred to the at least one metal-made and heat-conducting unit 2 and mixed with the air flow outside of the headlight casing 1. The heat can be quickly dissipated to increase efficiency of the light source 13. The at least one metal-made and heat-conducting unit 2 covers the at least one hole 11 so as to prevent water from entering into the headlight casing 1 to protect the circuit of the at least one light source 13.

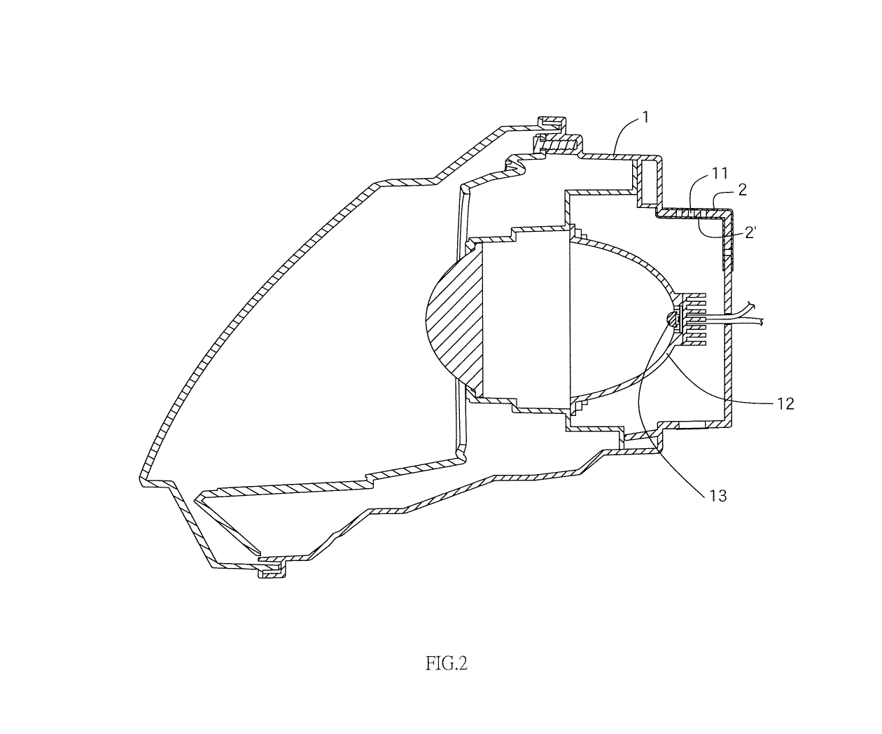

As shown in FIG. 2, there are two metal-made and heat-conducting units 2, 2′ connected to the outside of the headlight casing 1 and the inside of the headlight casing 1 to cover the at least one hole 11. The metal-made and heat-conducting unit 2 that is connected to the inside of the headlight casing 1 extends along the inside of the headlight casing 1. The two metal-made and heat-conducting units 2, 2′ respectively extend along the outside and inside of the headlight casing 1.

The heat transfer coefficient of each of the two metal-made and heat-conducting units 2, 2′ is higher than that of the material of the headlight casing 1, so that the metal-made and heat-conducting unit 2′ at the inside of the headlight casing 1 absorb the heat from the at least one light source 13 and passes the heat to the metal-made and heat-conducting unit 2 at the outside of the headlight casing 1. The metal-made and heat-conducting unit 2 at the outside of the headlight casing 1 extends along the outside of the headlight casing 1 such that the larger contact area with the air outside of the headlight casing 1 can quickly bring the heat away.

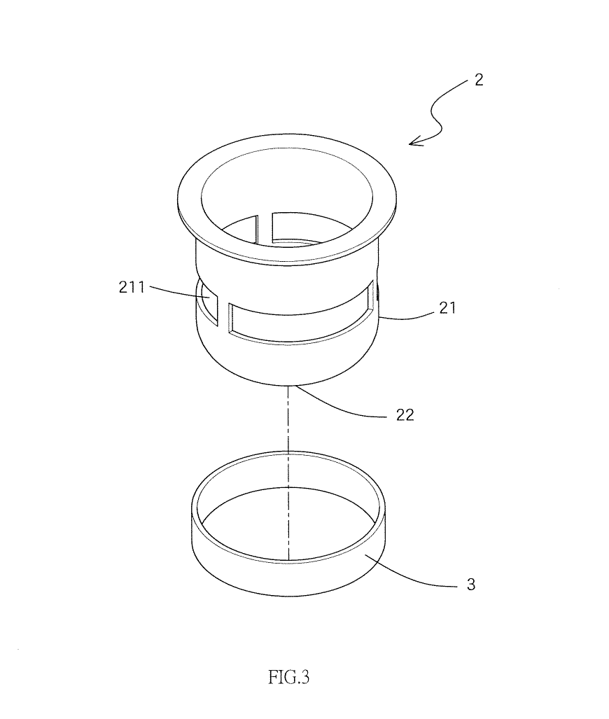

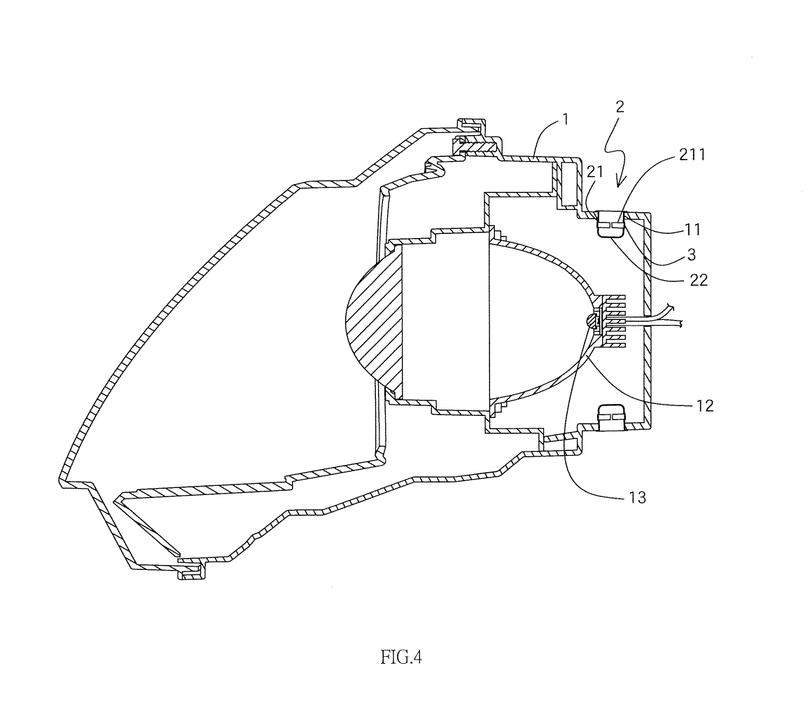

As shown in FIGS. 3 and 4, the metal-made and heat-conducting units 2 each have a sidewall 21 and a bent portion 22 which is connected to the lower end of the sidewall 21. The sidewall 21 is engaged with the at least one hole 11. The metal-made and heat-conducting units 2 each are a cup-shaped unit. The metal-made and heat-conducting units 2 each comprise at least one slot which communicates with the at least one hole. A water-proof and air-permeable unit 3 is mounted to each of the metal-made and heat-conducting units 2 and covers the at least one slot 211. Air is permeable through the water-proof and air-permeable unit 3 and water cannot pass through the water-proof and air-permeable unit 3.

The sidewall 21 and the bent portion 22 both increase the contact area between the air the metal-made and heat-conducting unit 2. The heat generated from the light source 13 is transferred to the metal-made and heat-conducting units 2 and can be brought away quickly. A portion of the hot air can also escaped by air passing through the water-proof and air-permeable unit 3. Water cannot enter into the headlight casing 1 so as to protect the circuit in the headlight casing 1. The water-proof and air-permeable unit 3 is mounted to the metal-made and heat-conducting unit 2, and the sidewall 21 is substantially perpendicular to the headlight casing 1 so that the water-proof and air-permeable unit 3 is protected from being broken by foreign forces. No extra protection device is needed for the water-proof and air-permeable unit 3.

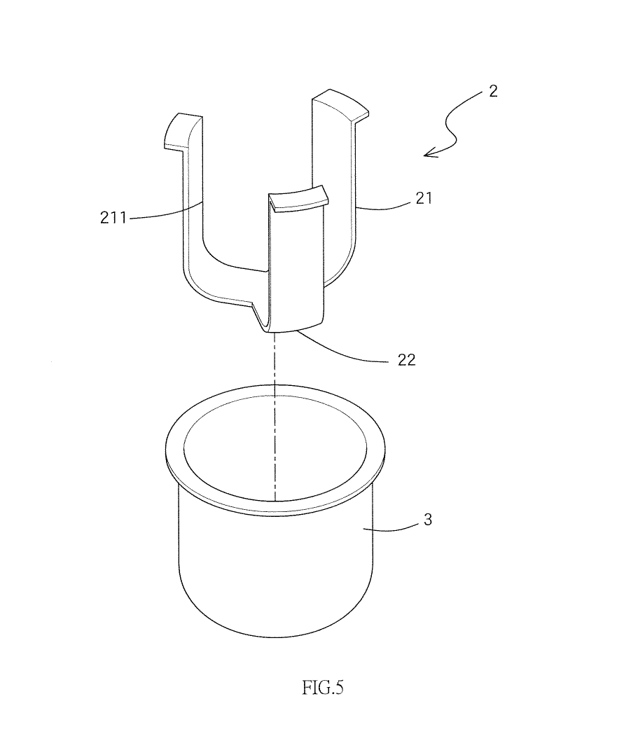

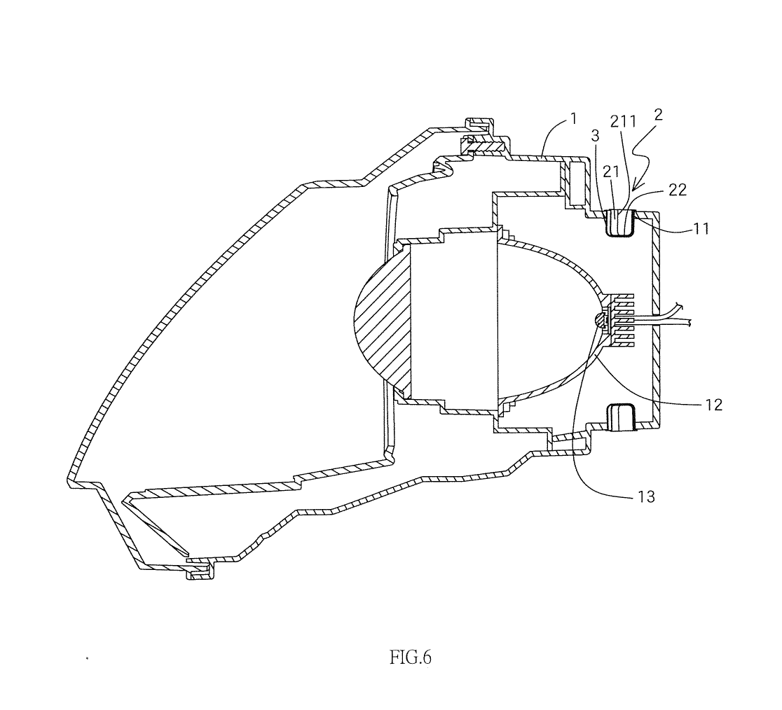

As shown in FIGS. 5 and 6, the sidewall 21 includes three elongate plate, each elongate plate is connected with the bent portion 22 which has the same width of each of the elongate plates. Slots 211 are formed between the elongate plates and the water-proof and air-permeable unit 3 is mounted to the metal-made and heat-conducting unit 2 and covers the slots 211.

The embodiment uses less metal material and the slots 211 provide good air ventilation. The heat energy is transferred to the metal-made and heat-conducting unit 2 and brought away by the air.

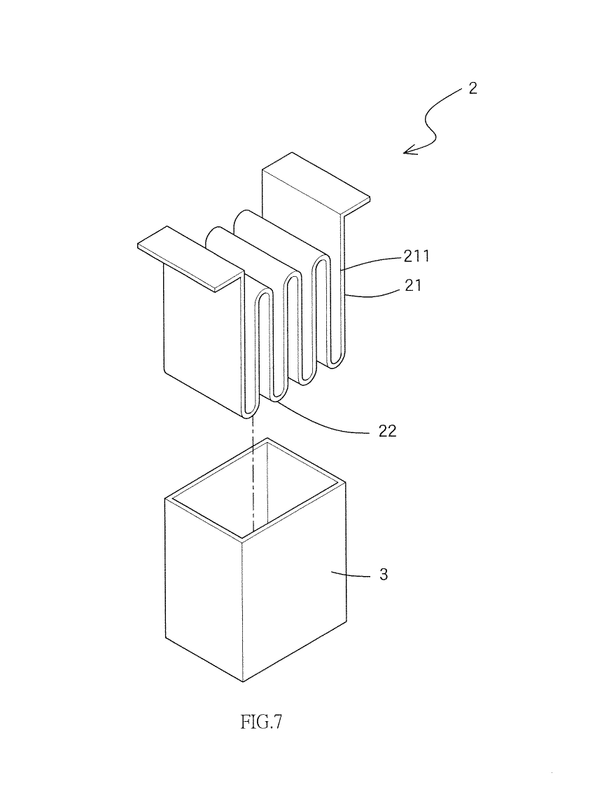

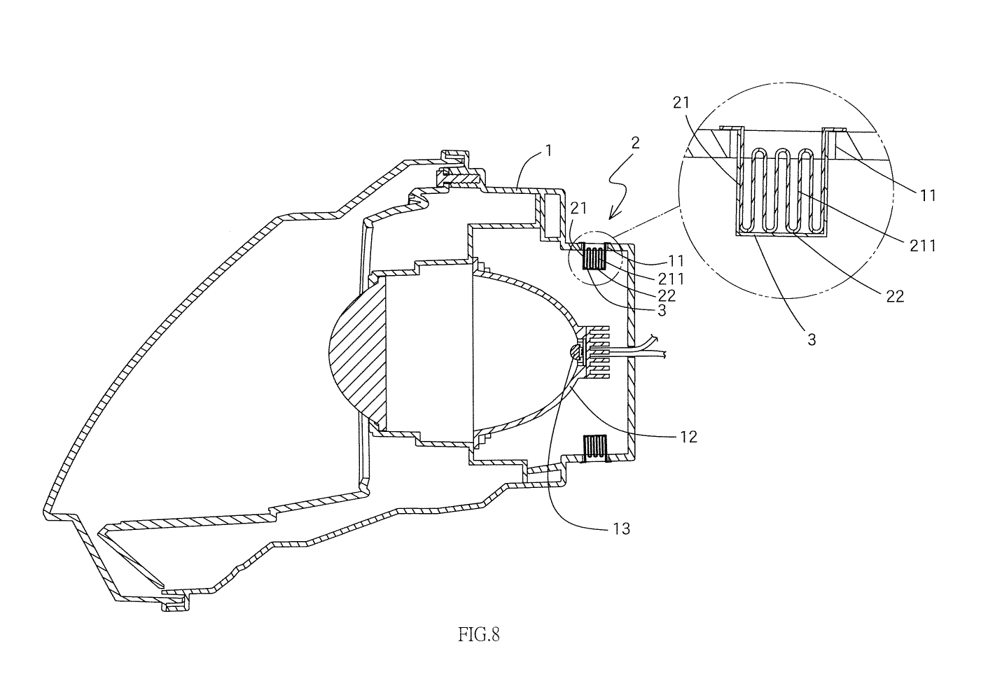

As shown in FIGS. 7 and 8, the metal-made and heat-conducting unit 2 comprises continuously bent potions 22 and each bent portion 22 has a U-shaped portion. The metal-made and heat-conducting unit 2 is in a form of board and the bent portions 22 are curved portions which are easily manufactured.

It is noted that the board-shaped of the metal-made and heat-conducting unit 2 is easily manufactured so that the board-shaped of the metal-made and heat-conducting unit 2 can be directly inserted into and secured to the hole 11 to reduce the manufacturing cost.

There are multiple slots 211 formed between the upright portions of the continuous bent portions, the water-proof and air-permeable unit 3 covers the slots 211 so as to increase the efficiency of heat dissipation. It is noted that the metal-made and heat-conducting unit 2 of the present invention is not limited to that as disclosed in FIGS. 7 and 8. The metal-made and heat-conducting unit 2 of the present invention can also be a curved board, multiple fins or the bent portion includes at least one U-shaped portion.

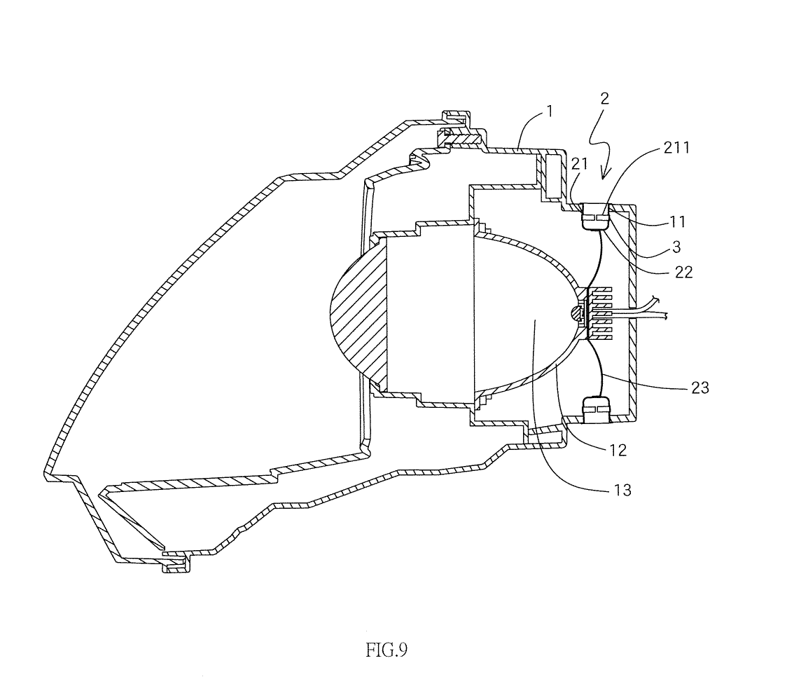

As shown in FIG. 9, the metal-made and heat-conducting unit 2 has an extension portion 23 located in the headlight casing 1. The extension portion 23 is a curved portion. The extension portion 23 is connected with the light source 13.

The heat generated from the light source 13 is directly transferred to the extension portion 23 and then the extension portion 12 transfers the heat to the metal-made and heat-conducting unit 2. The speed of the conduction is larger than that of the convection, so that the hole 11 does not have to be located at the top of the headlight casing 1. The curvature of the extension portion 11 can be easily adjusted according to the distance between the light source 13 and the metal-made and heat-conducting unit 2. Therefore, the extension portion 11 can be easily cooperated with different types of headlights.

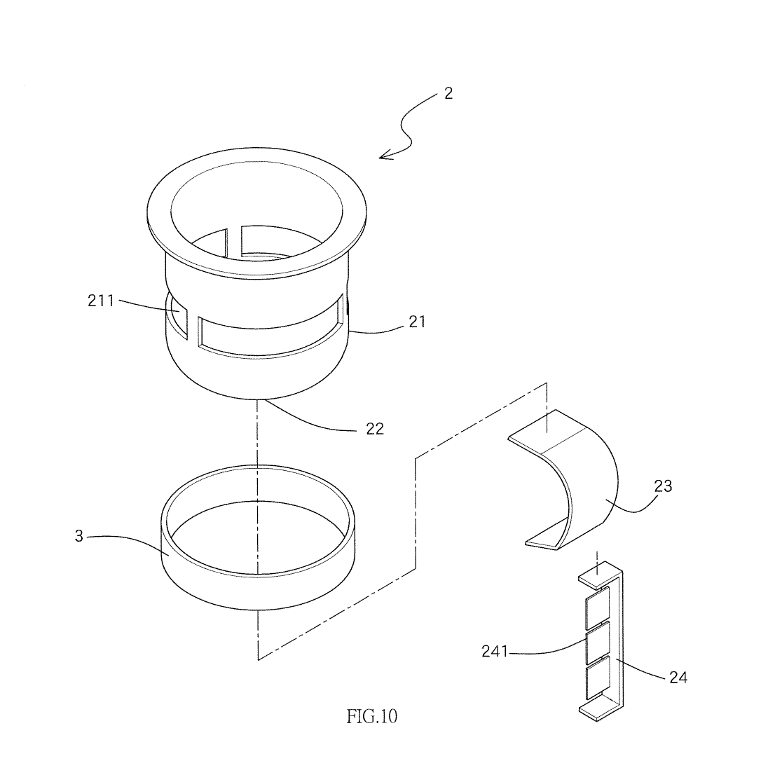

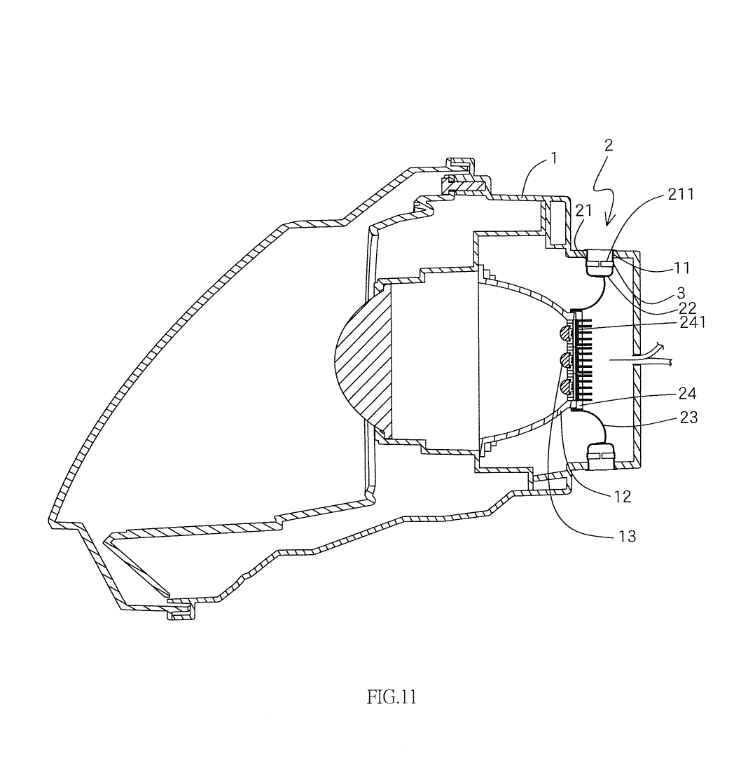

As shown in FIGS. 10 and 11, there are multiple light sources 13 in the headlight casing 1, and this embodiment further comprises a heat-conducting member 24 which has at least one connection portion 241 at one end thereof. The at least one connection portion 241 is connected to the light sources 13, and the other end of the heat-conducting member 24 is connected with the extension portion 23. The heat generated from the light sources 13 is transferred to the extension portions 23 via the at least one connection portion 241 and the heat-conducting member 24, and the heat is then transferred to the metal-made and heat-conducting unit 2.

While we have shown and described the embodiment in accordance with the present invention, it should be clear to those skilled in the art that further embodiments may be made without departing from the scope of the present invention.

What is claimed is:

1. A headlight heat dissipation device comprising:
a headlight casing having at least one hole, at least one metal-made and heat-conducting unit covering the at least one hole.

2. The device as claimed in claim 1, wherein the at least one metal-made and heat-conducting unit is board-shaped.

3. The device as claimed in claim 2, wherein there are two metal-made and heat-conducting units connected to an outside of the headlight casing and an inside of the headlight casing, the metal-made and heat-conducting unit that is connected to the inside of the headlight casing extends along the inside of the headlight casing.

4. The device as claimed in claim 1, wherein the at least one metal-made and heat-conducting unit has a sidewall and a bent portion which is connected to a lower end of the sidewall, the sidewall is engaged with the at least one hole.

5. The device as claimed in claim 4, wherein the at least one metal-made and heat-conducting unit is a cup-shaped unit.

6. The device as claimed in claim 4, wherein the sidewall includes three elongate plate, each elongate plate is connected with the bent portion which has the same width of each of the elongate plates.

7. The device as claimed in claim 4, wherein the at least one metal-made and heat-conducting unit comprises multiple fins.

8. The device as claimed in claim 4, wherein the at least one metal-made and heat-conducting unit comprises continuously bent potions and each bent portion has at least one U-shaped portion.

9. The device as claimed in claim 1, wherein the at least one metal-made and heat-conducting unit comprises at least one slot which communicates with the at least one hole, a water-proof and air-permeable unit is mounted to the at least one metal-made and heat-conducting unit and covers the at least one slot.

10. The device as claimed in claim 1, wherein the at least one hole is defined in a top of the headlight casing.

11. The device as claimed in claim 1, wherein the at least one metal-made and heat-conducting unit has an extension portion located in the headlight casing.

12. The device as claimed in claim 11, wherein the extension portion is a curved portion.

13. The device as claimed in claim 11, wherein the extension portion is connected with a heat-conducting member which has at least one connection portion.

14. The device as claimed in claim 11, wherein the casing has a headlight located therein, the headlight has at least one light source, the extension portion is connected to the at least one metal-made and heat-conducting unit and the light source.

15. The device as claimed in claim 14, wherein a heat-conducting member is connected with the extension portion and has at least one connection portion, the at least one connection portion is connected with the light source.

16. The device as claimed in claim 14, wherein the at least one light source comprises at least one Light Emitting Diode or a bulb.
